(19) United States
(12) Patent Application Publication
(10) Pub. No.: US 2002/0099625 A1
(43) Pub. Date: Jul. 25, 2002

(54) Method for designing and pricing of display unit packages for a display stand

(76) Inventor: Paul O'Brien, Long Beach, CA (US)

Correspondence Address: OPPENHEIMER WOLFF & DONNELLY LLP, ATTENTION: LOUIS J. BOVASSO, Suite 3800, 2029 Century Park East, Los Angeles, CA, 90067, US

(21) Appl. No.: 09/767,754

(22) Filed: Jan. 22, 2001

(51) Int. Cl. G06F 17/60

(52) U.S. Cl. 705/27; 705/26; 705/29

(57) ABSTRACT

A web-based method used over the internet to select a particular type and measurement of a unit package, then pricing a display stand to carry a plurality of such pre-selected unit packages. The computer user, after connecting to the web site and installation of the appropriate software, can select a particular type of hanging unit package having pre-selected dimensions, then determine the number of such unit packages that can be mounted to a display rack panel. The panel and display hook can then be ordered over the internet.

### BACKGROUND OF THE INVENTION

1. Field of the Invention

This invention relates to the designing and pricing of displays and, more particularly, to a computer interactive method of determining the type of display unit packages desired, then computing the number of unit packages and placement required, over the internet.

2. General Background and State of the Art

The designing and pricing of unit packages for display stands that are to be used in a retail store is a complicated process. Such unit packages are generally hung from a panel mounted on a freestanding wire stand in the store. Although a large variety of unit packages are known, usually four such unit packages are generally used. However, the size and placement of the hanging tabs of such unit packages vary. Thus, there are a large number of different configurations of unit packages that are to be mounted on a panel that is part of a wire display stand.

Electronic purchasing of a wide variety of goods over the internet has come into being in recent years. Since displays using unit packages must be custom made for the particular type of unit package to be mounted thereon, purchase of such over the internet has not been heretofore possible.

There is a need for a method for configuring the type and measurements of a unit packages to be used on a store display, then automatically determining the number and types of display hooks that can be used in a store display. Such a method should be easy to use by anyone over the internet with suitable access software for entering the web site and carrying out the method of determining the display needs required.

### INVENTION SUMMARY

It is an object of this invention to provide a web-based method used over the internet to select a particular type and measurement of a unit package, then pricing a display stand to carry a plurality of such pre-selected packages.

It is a further object of this invention to provide a web-based method using a computer and the internet to determine what type of display hook lengths and number of unit packages on each hook that can be used in a pre-selected display rack.

These and other objects are preferably accomplished by providing a web site on the internet where a user, after installation of the appropriate software, can select a particular type of hanging unit packages having pre-selected dimensions, then determine the number of such unit packages that can be mounted to a display rack panel. The panel and display hook can then be ordered over the internet.

### BRIEF DESCRIPTION OF THE DRAWINGS

FIG. 1 is a perspective view of four different types of unit packages that can be selected;

FIG. 2 is an elevational view of one of the unit packages of FIG. 1;

FIG. 3 is a side view of the unit package of FIG. 2;

FIG. 4 is a side view of another of the unit packages of FIG. 1;

FIG. 5 is a side view of still another of the unit packages of FIG. 1;

FIG. 6 is a side view of another of the unit packages of FIG. 1;

FIG. 7 is a graphical representation of a computer screen in one of the steps for carrying out the invention with data inserted into boxes on the screen display;

FIG. 8 is an elevational view of another of the unit packages of FIG. 1;

FIG. 9 is a graphical representation of a computer screen illustrating a selected layout in carrying out the steps of the invention;

FIG. 10 is a graphical representation of a computer screen illustrating a side view of the layout of FIG. 9; and

FIG. 11 is a graphical representation of a computer screen illustrating the final step in selecting unit packages for a pre-selected display stand in accordance with the teachings of the invention.

### DETAILED DESCRIPTION OF THE PREFERRED EMBODIMENTS

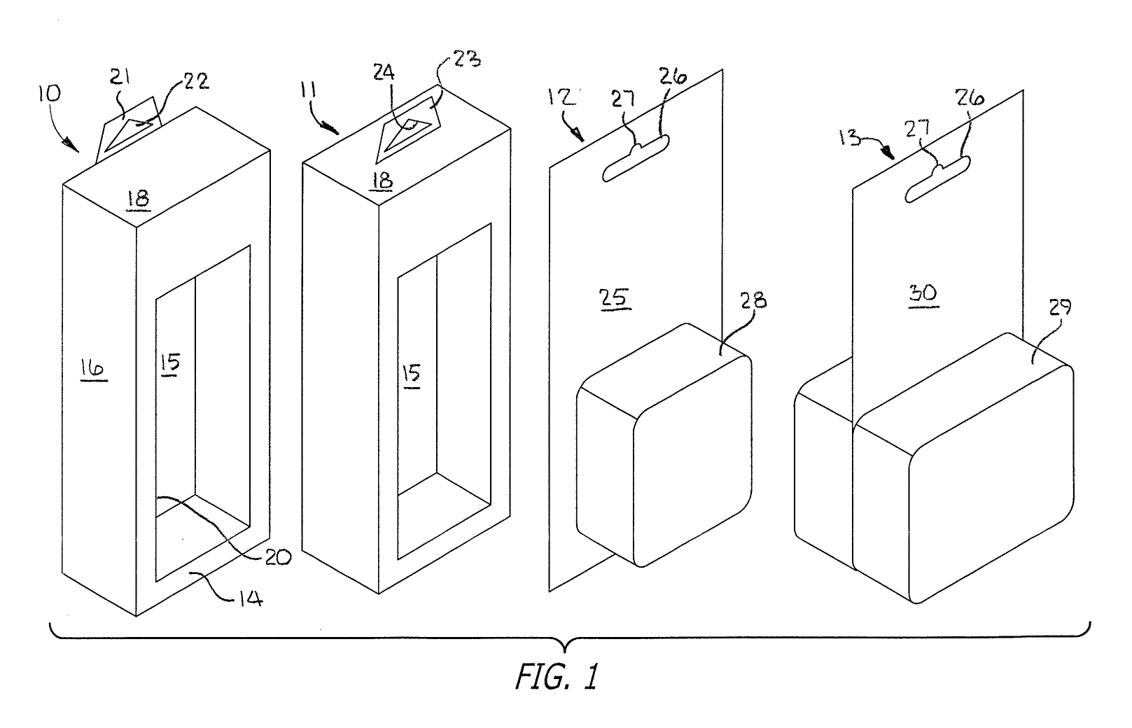

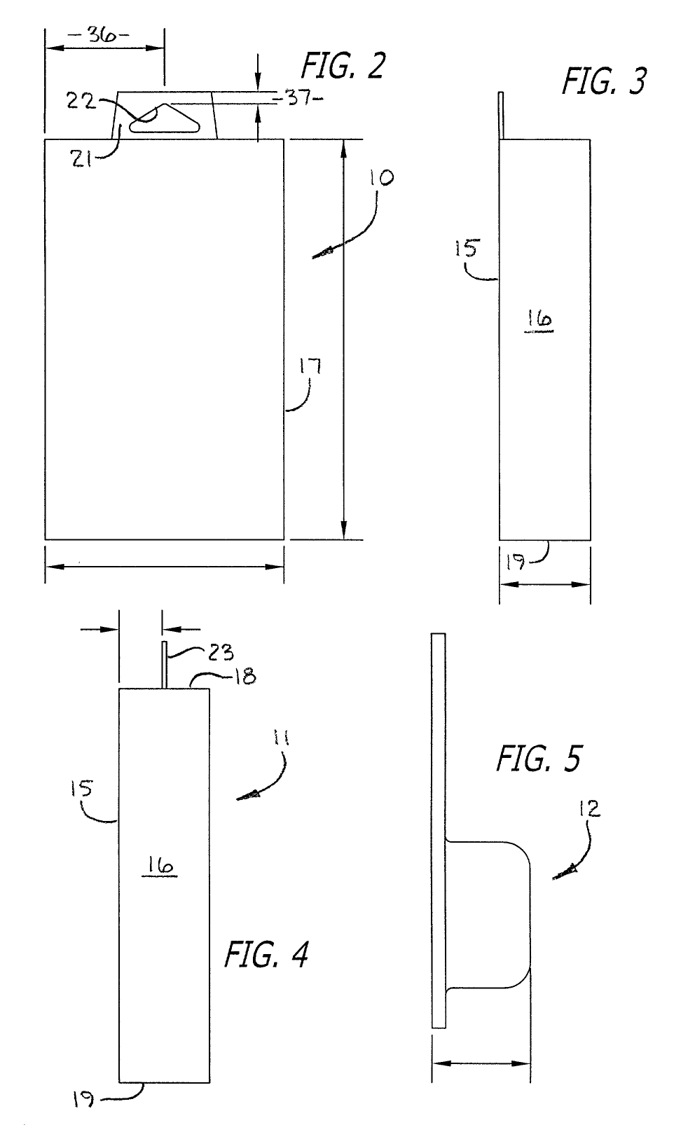

Referring now to FIG. 1 of the drawing, four conventional types of unit packages 10 through 13 are shown. Package 10 is generally rectangular in configuration having a front wall 14 spaced from a rear wall 15 and interconnected side walls 16, 17 (see also FIGS. 2 and 3). Package 10 also has a top wall 18 (FIG. 1) and a bottom wall 19 (FIG. 3). The front wall 14 (FIG. 1) has a rectangular opening 20 providing access into the interior of unit 10 where a product may be mounted and displayed. The package 10 in use may be blister- or cellophane-wrapped to provide a visual display of the product while protecting the same.

A hanging tab 21 is provided at top having an opening 22 therein, which may be generally triangular and pointed at top for hanging package 10 on a display hook, as will be discussed. As seen in FIG. 3, tab 21 is to the rear of package 10 extending upwardly from the rear wall 15.

Package 11 is identical to package 10, except for the location of its hanging tag 23, and thus like numerals refer to like parts of package 10. Tag 23 (FIG. 1) has an opening 24 therein identical to opening 22 in tab 21. As seen in FIGS. 1 and 4, tab 23 is mounted on top wall 18 between front and rear walls 14, 15.

Referring again to FIG. 1, package 12 is a unit package in the form of a blister card having a generally planar panel 25 with a slotted opening 26 having an upper hook receiving slot 27 for mounting package 12 on a display hook, as will be discussed.

A transparent blister 28 (see also FIG. 5) is mounted on the front of panel 25 above the bottom thereof. Blister 28 is of any suitable transparent plastic material allowing a product to be mounted therein and be visible to a customer.

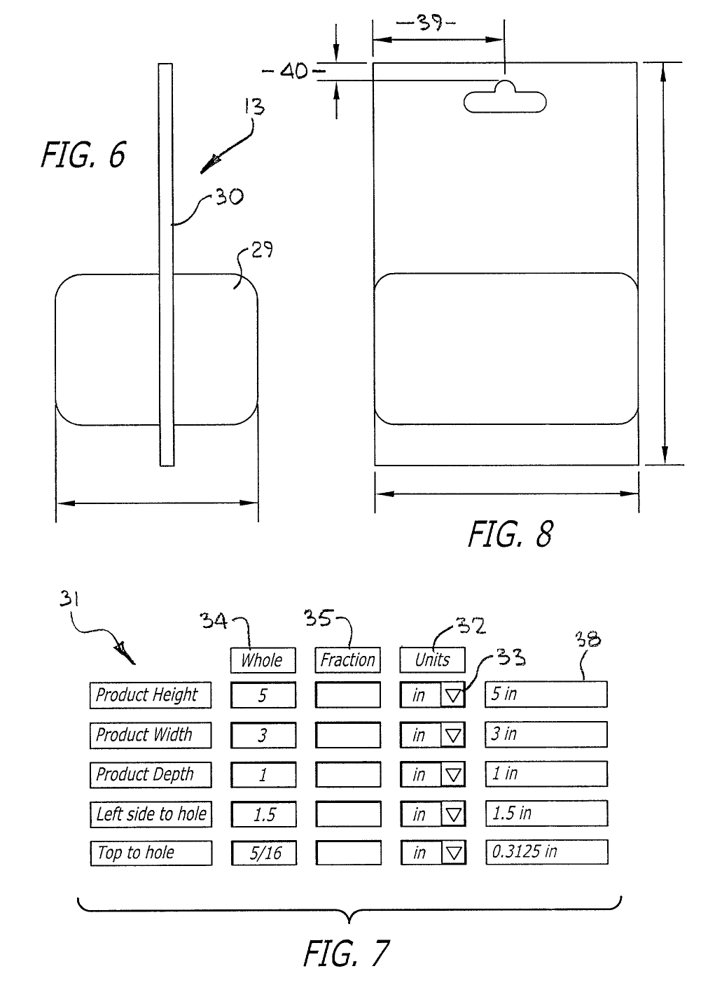

Referring again to FIG. 1, a unit package in the form of a blister card 13 is shown otherwise identical to card 12 except that blister 29, as seen in FIGS. 1 and 6, extends on both sides of panel 30. Slot 26 and upper slot 27 of card 13 are identical to slots 26, 27 of card 12.

Referring now to FIG. 7, a dimensions box 31 is presented to the customer on his or her computer screen after selection of one of the unit packages of FIG. 1. Dimensions box 31 is generally identical (except where indicated below) for each selected unit package and has listings for entry of product height, product width, product depth, left side to hole and top to hole. Such listings may be entered in inches (column 32), (or any other selected units of measurement by selection of down arrows 33) in whole numbers (column 34) or fractions (column 35).

For example, for unit package 10, the product height may be entered as 5″, the width as 3″, the depth as 1″, the left side to center of opening 22 in tab 21 as 1.5″ (see arrow 36 in FIG. 2) and the top of tab 21 to the apex of opening 22 as 5/16-inches (see arrow 37). As seen in FIG. 7, the values selected in inches appear in column 38.

The dimensions selected for unit package 11 may be the same except that a dimension for the distance of tab 23 from the wall 15 (FIG. 4) of unit package 11 must be selected (for example, ½-inch).

The dimensions selected for unit package 13 are identical to those shown as an example in FIG. 7. As seen in FIG. 8, the left side to hole measurement is determined by arrow 39 whereas the top to hole is determined by arrow 40. The back to hole is identical to the product depth.

The dimensions selected for unit package 12 are identical to those selected for unit package 13.

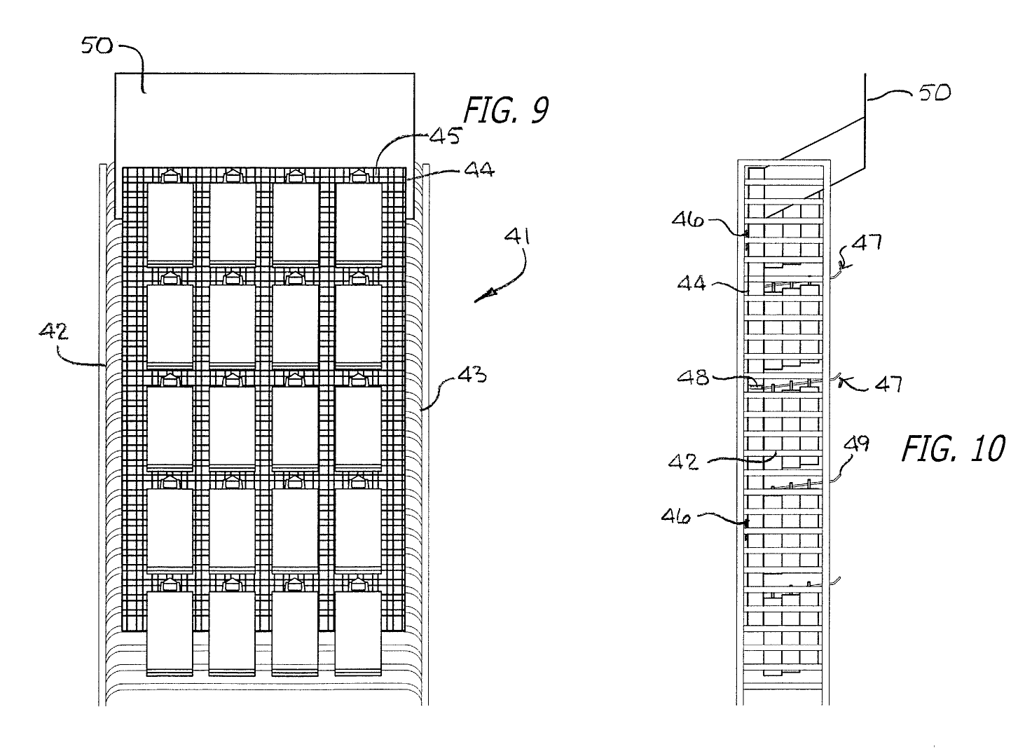

Once the dimensions for the selected unit package are entered, the customer moves forward to the display rack 41 of FIGS. 9 and 10. Rack 41 is a freestanding conventional wire rack having side walls 42, 43. A panel 44, having a plurality of spaced rows of slots 45, is mounted to rack 41 in any suitable manner, such as mounting clips 46 (see FIG. 10).

Slots 45 are adapted to receive therein display hooks 47, which may be of the type shown and described in my U.S. Pat. No. 4,671,417. In that patent, the display hook has a gripping finger that snaps into the slot 45 with an outwardly extending elongated finger, such as finger 48 (FIG. 10) terminating in an upturned end 49 for retaining unit packages of the type shown in FIG. 1 thereon. That is, fingers 48 extend through the openings in the tabs or slots of units 11 to 13 and the unit packages rest on the hooks 47 until removed by the customer.

A header panel 50 may be provided at top snap fitting into panel 44, as is well known in the art, for presenting advertising material thereon to the customer.

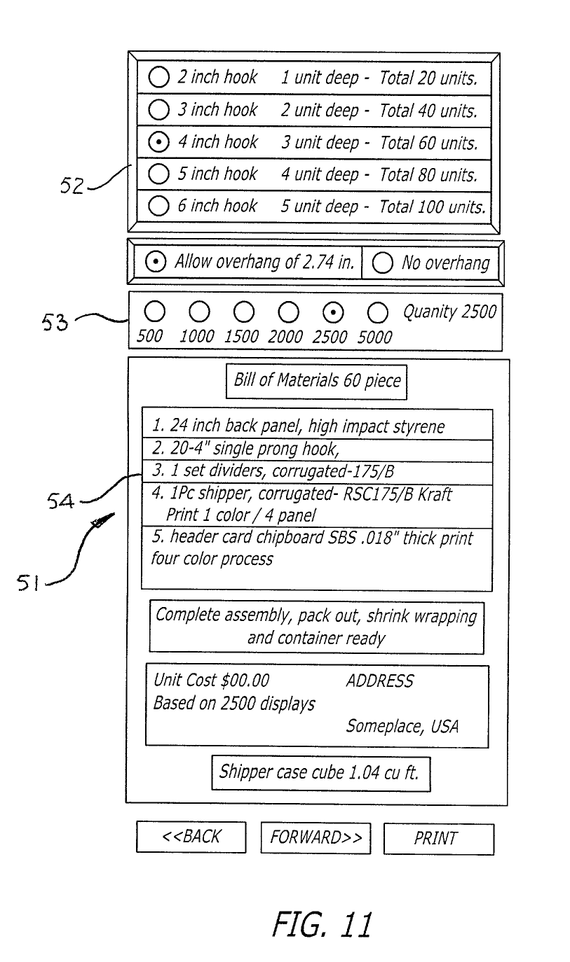

As seen in FIG. 11, an order form 51 appears on the user's computer screen along with the rack 43 and panel 44 when the particular unit package is selected. The order form has a first upper box 52 where the customer can select the particular length display hook 47 he or she would like to use (dependent on the number of unit packages that can be mounted thereon). Thus, as shown, selecting a 4-inch hook 47 indicates that three unit packages can be mounted on each hook for a total of 60 unit packages on panel 44 of FIGS. 9 and 10.

The customer can then select whether or not an overhang is desired. Looking at the next box 53, the number of unit packages to be ordered is selected (e.g.,

2,500 unit packages), the quantity being indicated on the customer's computer screen in box 53.

Looking at the next box 54, the bill of materials for each 60-piece unit package selected is displayed. For example, the following may be displayed in box 54

### Bill of Materials 60 Piece

1. 24 inch back panel, high impact styrene

2. 20-4″ single prong hook,

3. 1 set dividers, corrugated-175/B

4. 1 Pc shipper, corrugated-RSC175/B Kraft Print 1 color/4 panel

5. heater card chipboard SBS 0.018″ thick print four color process

The computer screen in box 54 may indicate the pricing for a complete assembly, packed out, shrink-wrapped and container ready. The unit package cost based on the number of unit packages selected may be shown along with the address and telephone numbers of the company selling the materials listed. The dimensions of the final container to be shipped may be given.

The back panel may be of any suitable material, such as high impact styrene, cardboard, injection molded plastic, etc. The display hooks 47 may be of any suitable type as is well known in the rack display art.

Obviously, the bill of materials and the number of hooks and dimensions of the panel 44 may be varied and is, of course, dependent on the type of unit packages selected in FIG. 1 and the dimensions thereof desired. Although four different unit packages are described and shown in FIG. 1, obviously various configurations may be used along with suitable dimensional relationships.

Although a particular embodiment of the invention is disclosed, variations thereof may occur to an artisan and the scope of the invention should only be limited by the scope of the appended claims.

We claim:

1. A method for selecting from a plurality of different unit packages the number and length of display hooks for hanging the selected unit packages from said hooks on a slotted panel coupled to a freestanding rack using a computer connected to a pre-selected web site over the internet comprising:
a computer having a monitor connected to a pre-selected web site over the internet displaying on the monitor a plurality of differing unit packages, each of said unit packages being three-dimensional and having a pair of spaced sides and an opening for receiving a display hook therein, and at least a height, a width, and a depth, said opening being spaced from the sides of said unit packages;
the user selecting one of said unit packages;
the computer presenting a dimensions box on said monitor in response to the unit package selected by said user;
the user inputting dimensions related to said height, width, depth, and spacing of said opening on said pre-selected unit package;
the computer presenting a display of a slotted display panel mounted on a rack along with a listing of the number of display hooks, and length thereof, that may be mounted to said panel dependent on the depth desired of the selected unit packages on each of said hooks;
the user inputting a selection of a particular length of display hook desired and the quantity thereof; and
the computer generating the bill of materials required for the number and length of hooks selected.

2. The method of claim 1 wherein at least one of said unit packages has a hanging tab with an opening therein, the step of inputting dimensions includes the step of inputting the dimensions relating to the position of said tab on said unit package.

3. The method of claim 1 wherein at least one of said unit packages has a slot therethrough with said opening therein, the step of inputting dimensions includes the step of inputting the dimensions relative to the position of said slot on said unit package.

4. The method of claim 1 wherein the step of generating the bill of materials includes the step of generating the dimensions and type of material of said panel.

5. The method of claim 1 wherein said computer, after computing said bill of materials, computes and displays to the user the cost of said materials selected along with information relating to the shipping of said materials.
